(19) United States
(12) Patent Application Publication
(10) Pub. No.: US 2002/0177337 A1
(43) Pub. Date: Nov. 28, 2002

(54) Connector of subscriber identity module (SIM) card with a card ejection device

(76) Inventor: Chen Chun-Lung, Taipei (TW)

Correspondence Address: RABIN & CHAMPAGNE, PC, 1101 14TH STREET, NW, SUITE 500, WASHINGTON, DC, 20005, US

(21) Appl. No.: 10/141,852

(22) Filed: May 10, 2002

(30) Foreign Application Priority Data
May 11, 2001 (TW) 090207782

(51) Int. Cl. H01R 13/62

(52) U.S. Cl. 439/152

(57) ABSTRACT

A connector of the subscriber identity module card with a card ejection device is disclosed and it can be implemented in a cellular phone. The connector of the subscriber identity module card includes a housing base and a card ejection device. The card ejection device comprises a member of the main body, a member for receiving the force, and a pushing member, all of which are used to push the SIM card out from the connector of the subscriber identity module card, and the member of the main body is implemented on an opening region of the house in a manner capable of sliding. In addition, the member for receiving the force is located at one end of the member of the main body and protrudes out from the opening region. Also, the pushing member is located at another end of the member of the main body and is disposed inside the connector of the subscriber identity module card, so as to contact with the SIM card. When the member for receiving force receives a force, it drives the member of the main body and the pushing member, in which the pushing member pushes the SIM card out.

This application incorporates by reference of Taiwan application Serial No. 090207782, filed May 11, 2002.

### BACKGROUND OF THE INVENTION

1. Field of the Invention

This invention relates to a connector of the subscriber identity module (SIM) card that can be implemented on a cellular phone. More particularly, the invention relates to a connector of the subscriber identity module card with a card ejection device, wherein the connector can be implemented on a cellular phone.

2. Description of Related Art

Nowadays, the cellular phone has become a part of the daily life. The cellular phone's qualities of being compact and lightweight make it portable and convenient for personal and business communications. It is very convenient for people to use the cellular phone in any time and at any place. For the usual digital cellular phone with a group special mobile (GSM) system, when a user subscribes a number for the cellular phone, the user will get a SIM card associated with the number of this cellular phone. The SIM card is implemented in a connector of the subscriber identity module for the cellular phone, so as to identify the legal user. It is also an important record about the history of communication and is used to record the account charges. In addition, the SIM card is a kind of microchip having the memory space to store the related information as backup data, which can be used by the user when the communication is taken, such as the personal phone book, the phone number of the cellular phone, and the communication parameters. Further still, since the SIM card is implemented in a connector of the subscriber identity module for the cellular phone, it allows the user to use the cellular phone, which is implemented with the SIM card.

As shown in FIG. 1A, a perspective drawing schematically illustrates a conventional structure for plugging the SIM card into the connector of the subscriber identity module. Referring to FIG. 1A, the connector of the subscriber identity module card 102 includes a plug slot 104, and the openings 106 and 108, in which the openings 106 and 108 are respectively located on the panels 110 and 112 of the connector of the subscriber identity module card 102. Also, the plug slot 104 and the openings 106 and 108 can be connected together, wherein the user can align a side 115 of the SIM card 114 to the opening 108, so that the SIM card 114 can be plugged into the plug slot 104 along the arrow direction 150 as shown in FIG. 1A. Further still, the SIM card 114 can be affixed to connector of the subscriber identity module card 102. In addition, a portion of the surface 116 of the SIM card 114 can be exposed to outside by the opening 106. In FIG. 1B, a perspective drawing schematically illustrates the view after the SIM card shown in FIG. 1A has been plugged into the connector of the subscriber identity module card. As shown in FIG. 1B, when the user intends to pull the SIM card 114 out from the connector of the subscriber identity module card 102, the user only needs to touch, by finger, the portion of the surface 116 of the SIM card 114 exposed to the outside by the opening 106. Additionally, the user can push the SIM card 114 with a force along the arrow direction 160 as shown in FIG. 1B, and then the SIM card 114 can be ejected from the plug slot 104 along the direction indicated by the arrow 160, also shown in FIG. 1A.

The SIM card and the connector of the subscriber identity module card usually only occupy a small hardware space in the cellular phone, and the SIM card is affixed to the connector of the subscriber identity module card by plugging in and ejecting out. Thus, the user cannot easily exert force directly on the surface of the SIM card for pushing the SIM card. If the user exerts too much force or in an incorrect way, then the SIM card will be scratched or damaged, which will affect the operation function of the SIM card. In addition, the surface of the SIM card usually is smooth and sliding. So that if the user's finger of the user has too much moisture, then the SIM card can not be pushed adequately due to insufficient friction. In this situation, it is necessary to use some auxiliary tool to take the SIM card out, and this is also very troublesome and time consuming.

### SUMMARY OF THE INVENTION

It is therefore an objective of the present invention to provide a connector of the subscriber identity module card with a card ejection device, in which the design of the card ejection device does allow the user to directly make use of the card ejection device to push out the SIM card from the connector of the subscriber identity module card. This is not only an improvement of convenience, but it also eliminates the need to directly exert force on the SIM card. Thus it can prevent the SIM card from being scratched.

In accordance with the foregoing and other objectives of the present invention, the invention provides a connector of the subscriber identity module card with a card ejection device, which can be plugged with a SIM card. The connector of the subscriber identity module card with the card ejection device includes a house and a card ejection device. The card ejection device comprises a member of the main body, a member for receiving the force, and a pushing member, all of which are used to push the SIM card out from the connector of the subscriber identity module card, and the member of the main body is implemented on an opening region of the house in a manner capable of sliding. In addition, the member for receiving the force is located at one end of the member of the main body and protrudes out from the opening region. Additionally, the pushing member is located at another end of the member of the main body and is disposed inside the connector of the subscriber identity module card, so as to be in contact with the SIM card. When the member for receiving force does receive a force, it drives the member of the main body and the pushing member, wherein the pushing member pushes the SIM card out.

In accordance with the foregoing and other objectives of the present invention, the invention provides a card ejection device, which can be implemented on a connector of the subscriber identity module card of a cellular phone, used to push the SIM card out, in which the SIM card is implemented into the connector of the subscriber identity module card. The ejection device includes a member of the main body, a member for receiving a force, and a pushing member. The member of the main body is implemented on a connector of the subscriber identity module card in a manner capable of sliding. In addition, the member for receiving the force is located at one end of the member of the main body and protrudes out from the connector of the subscriber identity module card, and the pushing member is located at another end of the member of the main body and is disposed inside the connector of the subscriber identity module card, so as to have contact with the SIM card. When the member for receiving the force receives a force, it drives the member of the main body and the pushing member, wherein the pushing member pushes the SIM card out.

### BRIEF DESCRIPTION OF DRAWINGS

The invention can be more fully understood by reading the following detailed description of the preferred embodiments, with reference made to the accompanying drawings, wherein:

FIG. 1A is a perspective drawing, schematically illustrating a conventional structure for plugging the SIM card into the connector of the subscriber identity module;

FIG. 1B is a perspective drawing, schematically illustrating the view after the SIM card shown in FIG. 1A has been plugged into the connector of the subscriber identity module card;

FIG. 2A is an enlarged view, schematically illustrating the structure of the connector of the subscriber identity module card with the ejection device, according to a preferred embodiment of the present invention;

FIG. 2B is a top view, schematically illustrating the connector of the subscriber identity module card with the ejection device of FIG. 2A;

FIG. 2C is a side view, schematically illustrating the connector of the subscriber identity module card with the ejection device of FIG. 2A;

FIG. 3A schematically illustrates a top view with respect to FIG. 2B, but after the SIM card has been ejected from the connector of the subscriber identity module card; and

FIG. 3B schematically illustrates a side view with respect to FIG. 3A, when the SIM card has been ejected from the connector of the subscriber identity module card.

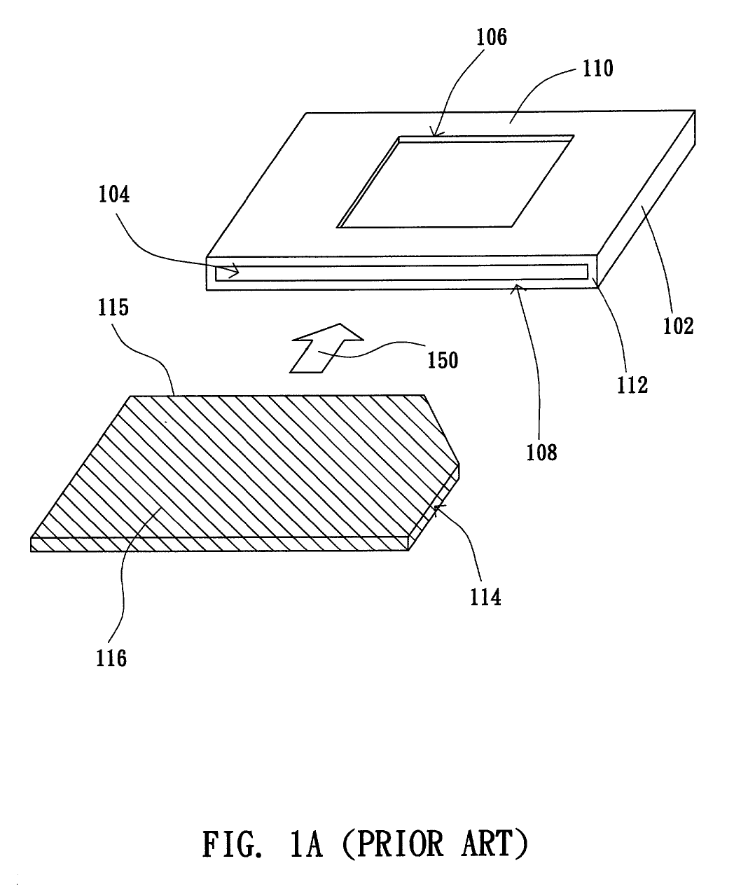

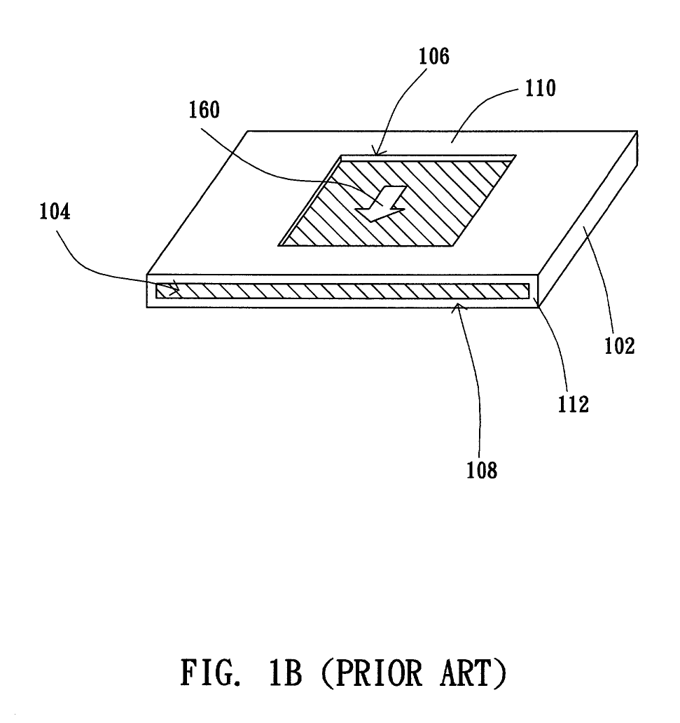

### DETAILED DESCRIPTION OF PREFERRED EMBODIMENTS

The present invention implements a card ejection device on a connector of a subscriber identity module (SIM) card in a cellular phone, so as to allow the user to directly exert the force on the card ejection device and to easily push the SIM card out from the connector of the subscriber identity module card. The operation is very convenient. In the following description of the preferred embodiment, only the relevant members of the cellular phone and the connector of the subscriber identity module card of the present invention will be described in detail.

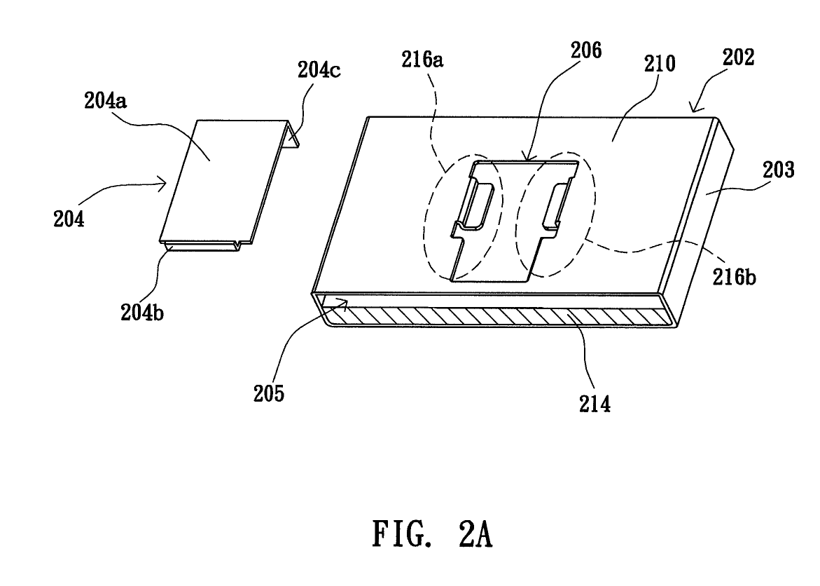

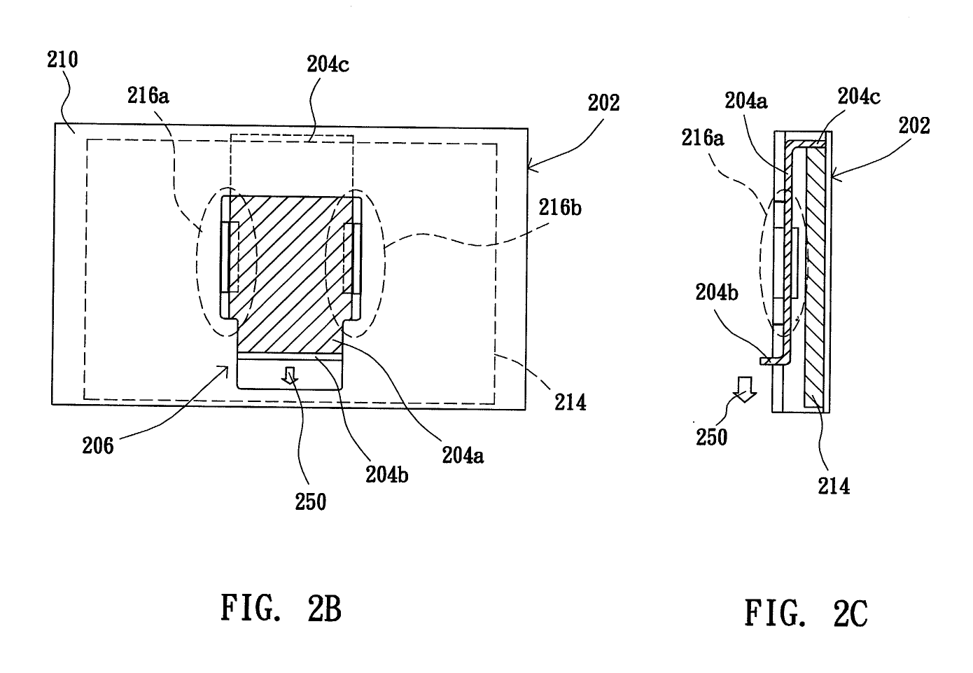

Referring to FIG. 2A, it is an enlarged schematic illustration of the structure of the connector of the subscriber identity module card with the ejection device, according to a preferred embodiment of the present invention. As shown in FIG. 2A, the connector of the subscriber identity module card 202 with card ejection device comprises a housing base 203, a card ejection device 204, a plug slot 205, and an opening 206, in which the opening 206 is located on a panel 210 of the housing base 203. Also, the plug slot 205 and the opening 206 are openings connecting to each other, wherein, the SIM card 214 can be plugged into the plug slot 205, and can be affixed to the connector of the subscriber identity module card 202. The card ejection device 204 includes a member of the main body 204a, a member for receiving the force 204b, and a pushing member 204c. The card ejection device 204 is used to provide the user to push the SIM card 214 out from the connector of the subscriber identity module card 202. The member of the main body 204a is implemented on the side of the opening region 206 at the sliding axis 216a and 216b in a manner capable of sliding. In addition, as shown in both FIG. 2B and FIG. 2C, the member for receiving force 204b is located at one end of the member of the main body 204a and protrudes out from the opening 206. Additionally, the pushing member 204c is located at another end of the member of the main body 204a and is disposed inside the connector of the subscriber identity module card 202, so as to have contact with the SIM card 214.

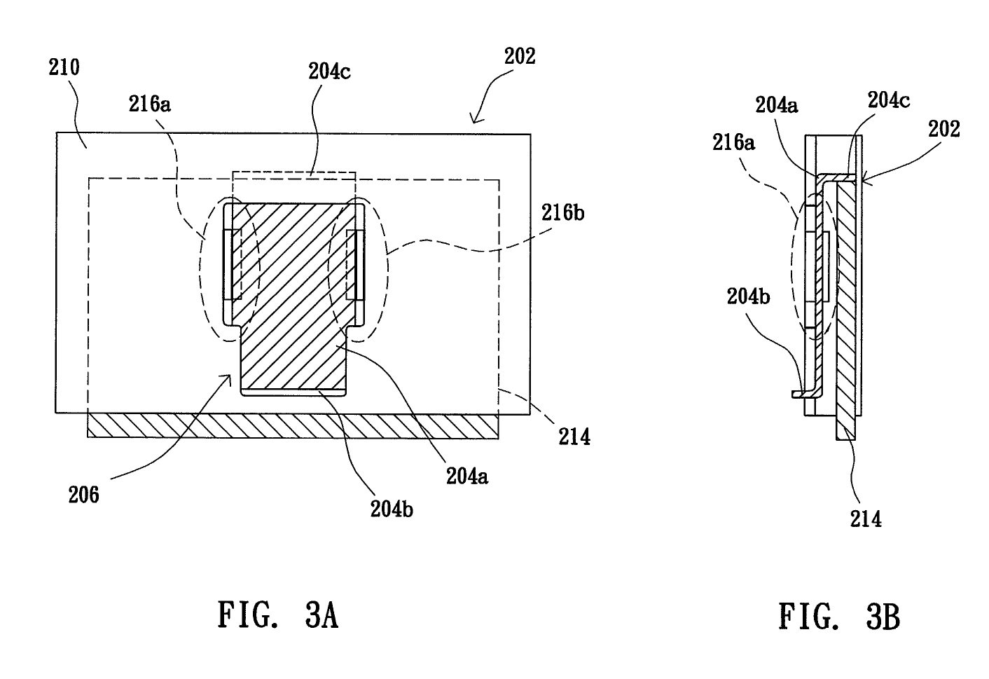

Referring to both the FIG. 2B and FIG. 2C, when the user exerts a force on the member for receiving force 204b along the direction indicated by the arrow 250, the member for receiving force 204b can drive the member of the main body 204a and the pushing member 204c to move along the direction of the arrow 250. Since one end of the SIM card 214 has contact with the pushing member 204c, the pushing member 204c can push the SIM card 214 out from the connector of the subscriber identity module card 202 along the direction of the arrow 250 when the pushing member 204c is moved, as shown in FIG. 3A and FIG. 3C.

During the procedure when the user is ejecting the SIM card 214 from the connector of the subscriber identity module card 202, the user does not directly touch the SIM card 214. This manner can prevent damage to the SIM card due to direct contact. The card ejection device 204 of the invention indeed allows the user to easily eject the SIM card 214, which is disposed in the connector of the subscriber identity module card 202. Comparing with the conventional manner to plug in and take out the SIM card, the invention is very convenient to operate.

Further still, the member of the main body 204a, the member for receiving the force 204b, and the pushing member 204c can be formed by integrating into a single structure. Any kind of design for the card ejection device 204 to be affixed to the connector of the subscriber identity module card by a method of sliding is within the scope of the present invention. In addition, when the user directly exerts the force onto the member of the main body 204a, it can also drive the pushing member 204c, so as to push the SIM card 214 out. Also, with respect to the connector of the subscriber identity module card, which can be implemented with several SIM cards, the connector of the subscriber identity module card can also be designed to have the foregoing ejection device, so that the user can eject a number of SIM cards quickly. This results in very convenient operation.

In summary of the foregoing preferred embodiment of the present invention, the connector of the subscriber identity module card with the card ejection device has been disclosed. The design of the card ejection device can allow the user to directly make use of the card ejection device to push the SIM card out of the MO102. The invention is convenient to operate, and it is not necessary for the user to exert the force directly on the SIM card, which also prevents the SIM card from being scratched in the process.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A connector of a subscriber identity module (SIM) card with a card ejection device, suitable for use in a cellular phone for plugging at least one SIM card, the connector of the subscriber identity module card comprising:
a housing base with an opening; and
a card ejection device, used to push the SIM card out from the connector of the subscriber identity module card, comprising:
a member of main body, implemented at a place on the opening with a manner capable of sliding;
a member of receiving force, located at a first end of the member of main body and protruding out from the opening; and
a pushing member, located at a second end of the member of main body opposite to the first end, and being inside of the connector of the subscriber identity module card, so as to have a contact with the SIM card,
wherein when the member of receiving force is exerted by a force, the member of receiving force drives the member of main body and the pushing member, so as to push the SIM card out by the pushing member.

2. The connector of the subscriber identity module card as recited in claim 1, wherein the member of main body, the member of receiving force, and the pushing member are integrated into a single structure in formation.

3. The connector of the subscriber identity module card as recited in claim 1, wherein the connector of the subscriber identity module card can be plugged with a plurality of SIM cards.

4. The connector of the subscriber identity module card as recited in claim 3, wherein when the member of receiving force is exerted by the force, the member of receiving force drives the member of main body and the pushing member, so as to push the SIM card out by the pushing member.

5. A card ejection device, which can be implemented on a connector of a subscriber identity module (SIM) card of a cellular phone, used to push at least one the SIM card out from the connector of subscriber identity module card, the ejection device comprising:
a member of main body, implemented on the connector of the subscriber identity module card by a manner capable of sliding;
a member of receiving force, located at a first end of the member of main body and protruding out from the connector of the subscriber identity module card; and
a pushing member, located at a second end of the member of main body opposite to the first end, and being inside of the connector of the subscriber identity module card, So as to have a contact with the SIM card,
wherein when the member of receiving force is exerted by a force, the member of receiving force drives the member of main body and the pushing member, so as to push the SIM card out by the pushing member.

6. The ejection device as recited in claim 5, wherein the member of main body, the member of receiving force, and the pushing member are integrated into a single structure in formation.

7. The ejection device as recited in claim 5, wherein the connector of the subscriber identity module card can be further plugged in with a plurality of SIM cards.

8. The ejection device as recited in claim 7, wherein when the member of receiving force is exerted by a force, the member of receiving force drives the member of main body and the pushing member, so as to push the SIM card out by the pushing member.
